(19) United States
(12) Patent Application Publication
(10) Pub. No.: US 2024/0057814 A1
(43) Pub. Date: Feb. 22, 2024

(54) METHOD AND SYSTEM FOR FRYING FOOD PRODUCTS BY AN INDUSTRIAL-ROBOTIC-AIR-FRYING SYSTEM (IRAFS)

(71) Applicant: KITCHEN ROBOTICS LTD, Modiin (IL)

(72) Inventors: Yair Gordin, Modiin (IL); David Ben-David, Rehovot (IL)

(73) Assignee: KITCHEN ROBOTICS LTD, Modiin (IL)

(21) Appl. No.: 18/385,553

(22) Filed: Oct. 31, 2023

Related U.S. Application Data
(63) Continuation-in-part of application No. 17/806,948, filed on Jun. 15, 2022.

(51) Int. Cl. A47J 37/06; A47J 44/00

(52) U.S. Cl. CPC A47J 37/0641; A47J 37/0664; A47J 44/00

(57) ABSTRACT

A new industrial-robotic-air-frying system (IRAFS) is disclosed. The new IRAFS may comprise a motion system, a dispenser that is configured to deliver one or more types of frozen products, and one or more air-frying Units (AFUs). Wherein the motion system is configured to take an empty frying-basket (FrB), to convey the empty FrB toward the dispenser for loading a certain amount of a certain frozen product into the FrB, and to convey the loaded FrB into an AFU from the one or more AFUs.

### CROSS-REFERENCE TO RELATED APPLICATIONS

This is a utility patent application being filed in the United States as a non-provisional application for patent under Title 35 U.S.C. § 100 et seq. and 37 C.F.R. § 1.53(b) and further, this application is related to the following concurrently filed United States non-provisional applications for patents, both of which are incorporated herein by reference in their entireties: (1) the application bearing the title of A FRYING BASKET (FrB) TO BE USED BY AN INDUSTRIAL-ROBOTIC-AIR-FRYING SYSTEM (IRAFS), identified by attorney docket number 11053.1130 and client docket number Kir-203-CON1 and (2) the application bearing the title of A CONTROLLER OF AN INDUSTRIAL-ROBOTIC-AIR-FRYING SYSTEM (IRAFS), identified by attorney docket number 11053.1140 and client docket number Kir-203-CON2. This application is also being filed as a continuation-in-part (CIP) application of the United States patent application filed on Jun. 15, 2022 and assigned Ser. No. 17/806,948, which application is incorporated herein by reference in its entirety.

### FIELD OF THE DISCLOSURE

The present disclosure relates to the field of an automated-cooking-restaurant (ACR) and more particularly the disclosure relates to a novel technique for frying food products by an industrial-robotic-air-frying system (IRAFS).

### BACKGROUND

Deep oil fryers are traditionally used to cook numerous food products. Products such as but not limited to french-fries, chicken, chicken wings, onion rings, etc. Usually, these food products are prepared from frozen ingredients. The throughput of such a deep oil fryer is about 60 pounds/hr (27.22 kg/hr). Along the present disclosure and the claims the terms oil, lard, fat may be used interchangeably and the term oil may be used as representative term of this group. Along the present disclosure and the claims the terms french-fries, chicken, chicken-wings and onion-rings can be used interchangeably and the term french-fries may be used as representative term of this group.

A common frying place in a commercial kitchen may comprise several sections. The first section is a frozen-dispenser that is configured to store frozen products, such as frozen french-fries, and to dispense a certain amount of frozen products into a frying-basket. The second section is the deep-oil-fryer (DOF). An operator, according to the type of product, sets the duration of frying and puts the frying-basket in the DOF. The next section is the fry-station, which can be referred also as serving section, in which the fried products are placed in order to be delivered to one or more customers. In some kitchens a seasoning station can be located after the serving section.

One of the major drawbacks of deep oil fryers is the labor necessary to handle used oil and the safety issues associated with filtering and replacing very hot oil. Another drawback of deep oil fryers is the cost of the oil that has to be replaced at the end of the day. In addition, the working conditions near a DOF are quite difficult. The operator need to stay near open container full of hot oil from which drops of hot oil may be splashed. Further, currently customers would like to get healthier food-products that are prepared by using less oil. On the other hand, the clients desire that the healthier food still has the taste, texture and mouth feel associated with the deep oil frying process.

### BRIEF SUMMARY

The needs and the deficiencies that are described above are not intended to limit the scope of the inventive concepts of the present disclosure in any manner. The needs are presented for illustration only. The disclosure is directed to a novel technique for an industrial-robotic-air-frying system that can deliver the throughput of deep oil fryer as well as the taste, texture and mouth feel associated with the deep oil frying process.

An example embodiment of the disclosed system may comprise a motion system, a frying-basket, a frozen-dispenser, an air-frying Unit (AFU), and a fry-station. A controller can be used in order to control the operation of the entire system. Some example embodiments may further comprise a topping unit or seasoning station. The frozen-dispenser and the fry-station can be similar to the units that are currently in use and will not be further disclosed. An example of a motion system may be a robotic-arm (R-arm) or a multi-axis gantry motion system. Along the present disclosure and the claims the term R-arm may be used as a representative term for any motion system that may move a frying-basket. Embodiments of R-arm are well known to a person skilled in the art and will not be further disclosed.

The far end of the R-arm can be associated with a holding mechanism (HM). An example of HM can be an electromagnet. Another example of HM can be adaptive-gripper-fingers that are configured to hold a frying-basket (FrB). The FrB is configured to contain items to be fried. In some embodiments, in which the HM is an electromagnet, the FrB can be associated with one or more metal plates, for example. In some embodiments a first metal plate can be attached to the right wall of the FrB, a second metal plate can be attached to the left wall of the FrB and the 3^{rd} one can be attached to the near wall, and the 4^{th} metal plate can be associated with the far wall of the FrB. The directions right, left, near and far are from the eyes of an operator that stands in front of the industrial-robotic-air-frying system (IRAFS).

In addition, the FrB can be associated with a cover. An example of cover can have two or more clips. The clips are configured to be associated with the walls of the FrB in order to hold the cover at the top of the FrB. In some embodiments the cover can be associated with a piece of metal. An embodiment of a cover may have 8 clips, for example, two on each side of the cover. Other example embodiments may have other number of clips, four for example, one at each side of the cover. Other may have six clips, two at each long sides and one on each short side, etc.

Other example embodiments of the disclosed technique may hold associate a cover with a FrB by using slots along the top edge of each side wall and configuring the R-arm to slide the cover in the slots. Yet, another example embodiment of the disclosed technique may associate one side of a cover with one or more pivots to the top edge of one of the walls and a locking-mechanism on the other side of the cover. An example for a locking-mechanism can be one or more clips. Alternatively, the locking mechanism may comprise a pin and an actuator that is configured to push the pin over the cover in order to associate it with the FrB. The actuator can be an electrical solenoid that can push or pull the pin against a spring, for example. The actuator can be controlled by the R-Arm.

An example of AFU may have two chambers an external chamber and an internal chamber. The chambers may have a shape of cylinder having a door for enabling the R-Arm to place a FrB inside the internal chamber. A gap between the two chambers is used for circulating the hot air. Hot air is drained of the gap into the internal chamber, the air fryer chamber, by one or more blower-assemblies. In the internal chamber the hot air is directed at a food product that is in the FrB. An example of a blower-assembly may comprise a blower motor, a blower wheel and a thermal heating source such as but not limited to heating coil.

Some example embodiments of an AFU may comprise an open drawer that can be located at the bottom of the internal chamber and is configured to obtain remains of oil or products that were fried in that AFU.

In some embodiments the FrB can be revolved by a motor, thus the pieces of the product are mixed during the cooking process. From the internal chamber the hot gas can be drained into the gap via one or more openings that are located over the surface of the internal chamber. Some of those openings can be associated with a thermometer. Other openings can be associated with a blower-assembly. Each blower-assembly can be associated with a thermal heating source. One or more thermal sensors can be placed in the flow of gas. A thermal sensor can be placed in the flow that is drained of the internal chamber. Other one or more thermal sensors can be placed in the flow of gas that is drain by the blower-assembly before entering to the frying chamber (the internal chamber). In some embodiments the gas is air.

In some example embodiments a controller may obtain the reading of the thermal sensors, and by knowing the type of product, the weight of the product in the FrB and the elapsed time it may increase or decrease the power to one or more thermal heating source. In some embodiments the controller may control also the speed of the flow of the hot air by controlling the rotation speed of the blowers.

In some example embodiments of the disclosed technique the internal chamber may have a motor that is associated with an engaging mechanism. The engaging mechanism can be configured to engage a close FrB with the motor. An example of the engaging mechanism may comprise adaptive-gripper-fingers. In another example embodiment of an AFU the engaging mechanism may comprise an electromagnet that is configured to engage the motor with the FrB via a metal plate that is associated with one of the walls of the FrB, the far wall for example. The motor is configured to spin the FrB while a spray of oil is splash over the revolved FrB in order to coat the products that is in the FrB. The coating can be implemented before activating the hot air. In some example embodiments of the disclosed technique the coating and or the topping can be implemented in another unit separately from the AFU.

Some examples of the robotic arm can be associated with a weighting apparatus. In such embodiment the weighting apparatus may measure the exact weight of the products that were delivered from the frozen-dispenser. The exact weight can be delivered to the controller in order to define the duration and/or the temperature to be used for frying that FrB. An example of a weighting apparatus is disclosed in U.S. patent application Ser. No. 17/806,948, which is incorporated herein by reference in its entirety

Following is an example process that can be implemented by an embodiment of the disclosed technique in order to fry a certain product. The process is managed by the controller. The process may be initiated by prompting the operator to define the type of product and the amount. The amount can be defined by describing the dish (huge, big, medium, small, etc.) Other example embodiment may define the weight of the current dish. Then, the robotic arm may fetch an empty FrB and push it into an appropriate slot of the frozen-dispenser, which is already aware of the desired amount. Then the R-Arm may close the FrB with the appropriate cover.

Next, the closed FrB is delivered by the robotic arm into the internal chamber of the Air-Fryer and be attached to the electromagnet that is associated with the revolving-motor. In some example embodiments the revolving-motor can be associated with the back wall (the far wall of the internal chamber. The R-Arm can move back and out from the internal chamber. Then the R-arm may close the doors of the internal chamber and the external chamber. At this point of time the coating process can be initiated by rotating the FrB, by the revolving-motor, while spraying oil over the FrB thus coating each of the product with oil. After coating the products the air-frying can be started at an appropriate temperature and for an appropriate duration according to the type of the product and the current amount. At the end of the air-frying cycle the chamber can be opened and the R-Arm can take the FrB with the fried products, removes the cover of the and turns the FrB over the fry-station.

An example of coating mechanism may comprise a pipe along the top of the internal chamber. The pipe can be associated with a plurality of nozzles. The end of the pipe that is near the door can be blocked the other end of the pipe is associated with a container of oil via a pump. In such embodiment the pump is configured to drain oil from the container and push it toward the nozzles for spraying the products that are in the FrB.

In some cases at the end of the air-frying cycle a topping process can be initiated. The topping process can be similar to the coating process and may be implemented by a topping mechanism, which can be similar to the coating mechanism having a topping material instead of oil. In some embodiments the pump and the nozzles can be adapted to the topping material. In some example embodiments of the disclosed technique the coating and or the topping can be implemented in another unit separately from the AFU.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which\:

FIG. 1 schematically illustrates a block diagram with relevant elements of an example of an Industrial-Robotic-Air-Frying System (IRAFS);

FIG. 2 schematically illustrates a cut along the side view of an example of an Air-Fryer-Unit (AFU);

FIGS. 3A to 3C schematically illustrate different embodiments of frying-baskets (FrB);

FIGS. 4A and 4B schematically illustrates a flowchart with relevant actions of an example process that can be implemented by a controller of an example of IRAFS in order to air frying a certain product.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. In addition the figures are drawn out of scale. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. In addition the terms element and section can be used interchangeably.

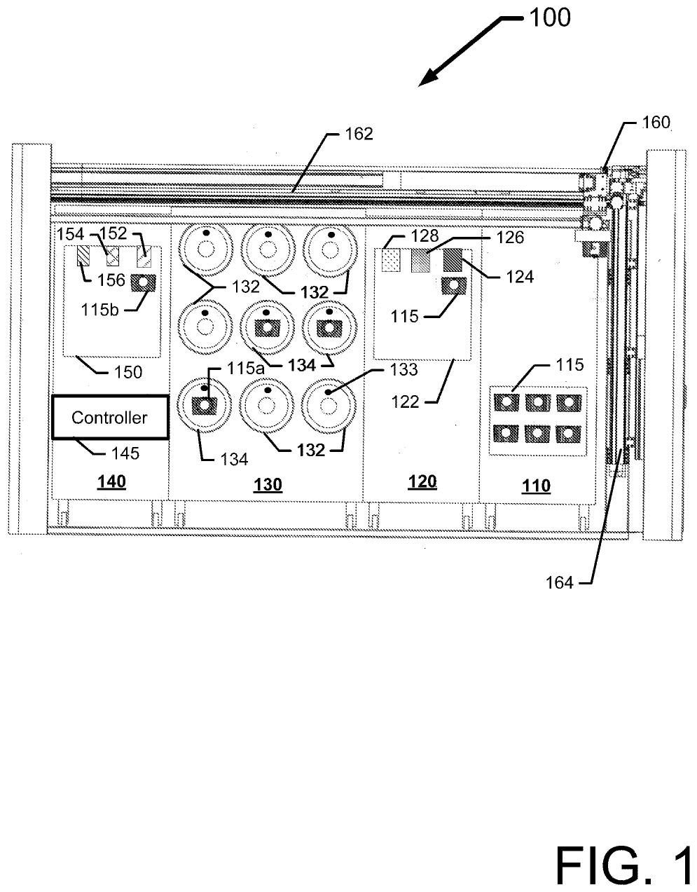

FIG. 1 schematically illustrates a front view of an example of an Industrial-Robotic-Air-Frying System (IRAFS) 100. An example of IRAFS 100 may comprise one or more racks and a motion-system. In FIG. 1 four racks (110, 120, 130 and 140) are illustrated as an example. Other embodiments of IRAFS 100 may comprise other number of racks, three racks for example. In addition the motion system in FIG. 1 is multi-axis gantry motion system 160. The motion-system 160 can be configured to carry a holding mechanism (HM) along X axis by leading-screw 162, along the Y axis by leading-screw 164 and along the Z axis by a 3^{rd} leading-screw, which is not shown in the figures. Each leading-screw is associated with a motor that is controlled by controller 145. An example of HM can be an electromagnet that is configured to pull and hold a FrB. Another example of HM can be adaptive-gripper-fingers that are configured to hold an FrB. Other example embodiments (not shown in the figures) of motion system 160 can be rack and pinion, pulley and belt, magnetic-linear motor, etc.

Other example embodiment of IRAFS (not shown in the figures) can be associated with a robotic-arm (R-arm). The far end of the R-arm can be associated with a HM. An example of HM can be an electromagnet. Another example of HM can be adaptive-gripper-fingers that are configured to hold a FrB.

The HM of the R-arm or the HM of IRAFS 100 can be associated with a weighting apparatus (not shown in the figures). In such embodiment the weighting apparatus may measure the exact weight of the products that were delivered from the frozen-dispenser 122. The exact weight can be delivered to the controller 145 in order to define the duration and/or the temperature to be used for frying that FrB. An example of a weighting apparatus is disclosed in U.S. patent application Ser. No. 17/806,948, which is incorporated herein by reference in its entirety.

The first rack 110 may store a plurality of empty clean FrBs 115 ready to be used. Rack 120 may comprise a frozen-dispenser 122 that is configured to store frozen products. Products such as but not limited to frozen french-fries 124, frozen-chicken-wings 126, frozen onion rings 128, etc. . . . Frozen-dispenser 122 can be configured to dispense a certain amount of frozen products into a frying-basket 115. The amount can be defined based on the type of product and the number of courses that are needed.

Rack 130 may comprise a plurality of air-frying Units (AFUs) 132 and 134. Each AFU can be associated with a coating pipe 133. One end of the coating-pipe is close while the other end is associated with a container of oil via a pump. The pump is configured to push oil from the container into the coating pipe 133. In addition the coating-pipe 133 may have a plurality of nozzles for spraying oil over the products that are in the FrB. In some embodiments (not shown in the figures) each AFU can be associated with two pipes. One pipe can be used for coating and the other pipe can be used for topping. The topping can be executed after the frying process.

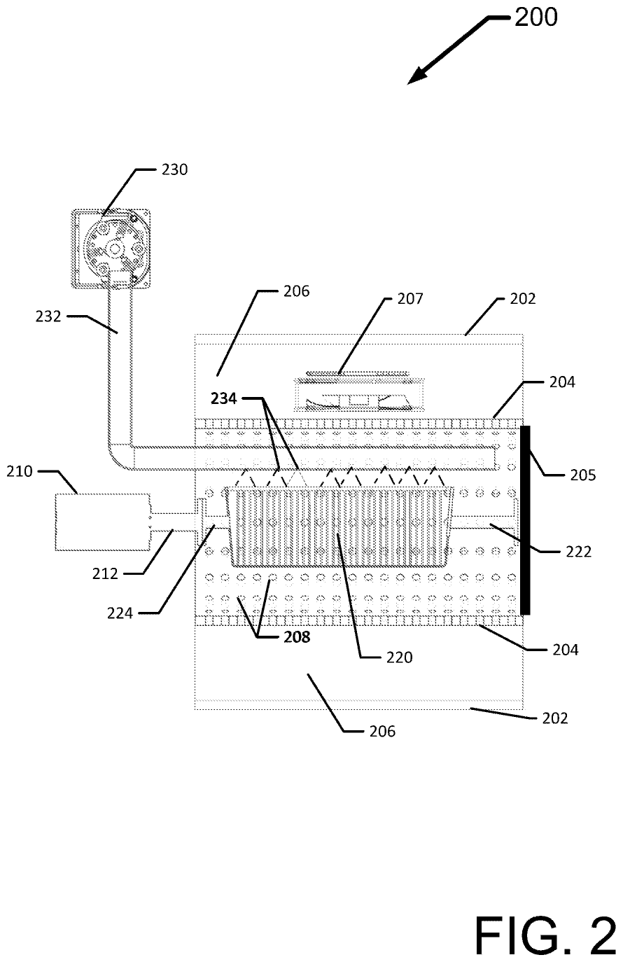

In FIG. 1 nine AFUs are associated with rack 130. However, other example embodiments of rack 130 may have other number of AFUs, six AFU for example. In rack 130, five of the AFUs 132 are currently not in used while four of the AFUs 134 are currently in used. Each one of the AFU 134 is associated with a FrB 115a. Each FrB 115a can be loaded with a different product. Each AFU 134 may be controlled independently from the other AFUs. The temperature of the hot air and the flow speed of the hot air the duration can be different from one active AFU 134 to the other. More information about the AFU is disclosed below in conjunction with FIG. 2.

Rack 140 may comprise a topping unit 150 and a controller 145. Toping unit 150 may comprise one or more topping stations. Topping station 152 may scatter salt, station 154 may inject mayonnaise and station 156 may inject ketchup, for example. Some example embodiments of the motion system 160 can be configured to revolve the FrB 115b, with the fried products, while delivering the topping. In some example embodiments topping unit 150 can be associated with an open drawer (not shown) for collecting the extra topping that missed the fried product.

Controller 145 can be configured to control the operation of the Industrial-Robotic-Air-Frying System (IRAFS) 100 according to instructions that are obtained from an operator of IRAFS 100. Controller 145 may comprise a non-transitory computer readable storage device and a processor. The processor can be a computer such as but not limited to Intel NUC, wherein NUC stands for Next-Unit-of-Computing or “Amazon EC2 A1 Instances” or “Amazon EC2 P3 Instances”, which are maintained by Amazon Crop USA, for example. Other example embodiments of the disclosed technique may use cloud resources as processors, servers, non-transitory computer readable storage devices, etc.

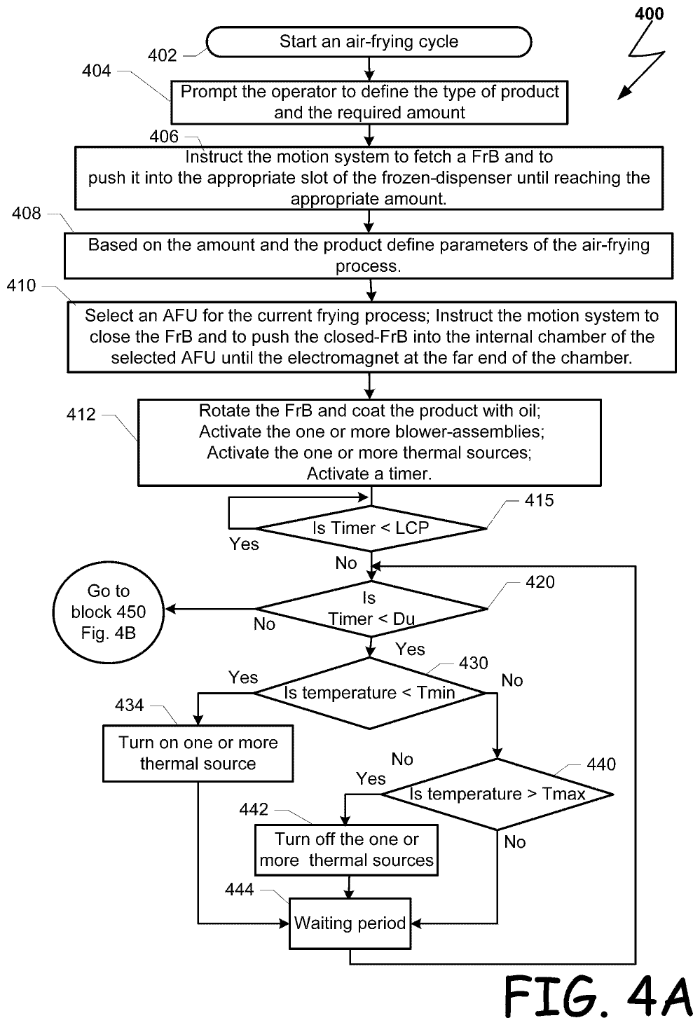

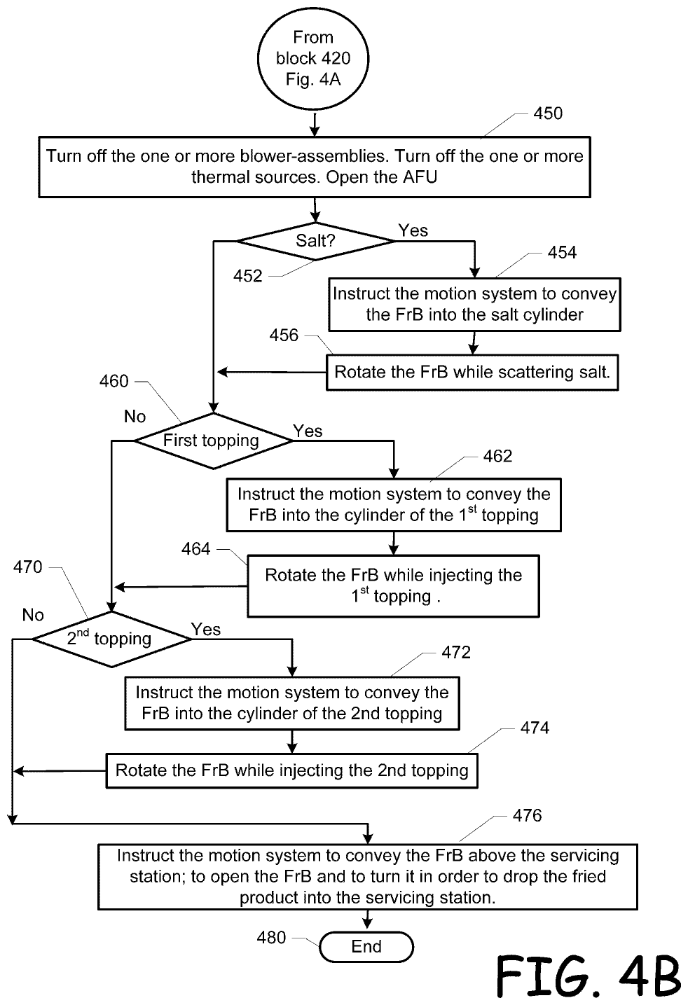

Software to be used by controller 145 may be embodied on a computer readable storage device such as but not limited to a read/write solid-state disc (SSD), CDROM, Flash memory, ROM, or other non-transitory computer readable storage device, etc. In order to execute a certain task a software program may be loaded to an appropriate processor as needed. In the present disclosure the terms task, method, process can be used interchangeably. More information on the operation of controller 145 is disclosed below in conjunction with FIGS. 4A and 4B.

FIG. 2. Illustrates a cut along the side view of an example of an Air-Fryer-Unit (AFU) 200. AFU 200 may comprise an external-chamber 202 an internal-chamber 204 and a gap 206 between the two chambers. In the example of FIG. 2 the two chambers has a shape of a cylinder. The surface of the internal chamber 204 can be associated with a plurality of openings 208. One side of the internal-chamber 204 can be associated with a door 205 through which a basket 220 can be pushed in or pulled out by a motion system. In some example embodiments of the disclosed technique the motion system may comprise a R-Arm that is associated with an electromagnet (not shown in the figures).

The other side of the internal-chamber 204 can be associated with a motor 210 having an engaging mechanism 212. The engaging mechanism 212 can be configured to engage the basket 220 with the motor 210. An example of the engaging mechanism 212 may comprise may comprise an electromagnet that is configured to engage the motor 210 with the basket 220 via a metal plate 224 that is associated with one of the walls of the basket 220, The other side of basket 220 can be associated with metal plate 222 that is configured to be associated with an electromagnet of the motion system. Other example embodiments of AFU 200 (not shown in the figures) may use adaptive-gripper-fingers as the engaging mechanism.

The motor 210 is configured to spin the basket 220 while a spray of oil is splash from pipe 232 over the revolved basket in order to coat the product that is in the basket 220. The coating can be implemented before activating the hot air. In some example embodiments of the disclosed technique the coating and or the topping can be implemented in another unit separately from the AFU 200.

The pipe 232 can be located along the top of the internal chamber 204. The pipe 232 can be associated with a plurality of nozzles 234. The end of the pipe that is near the door 205 can be blocked the other end of the pipe 232 is associated with a container of oil via a pump 230. In such embodiment the pump 230 is configured to drain oil from the container and push it toward the nozzles 234 for spraying the products that are in the basket 220.

AFU 200 can be associated with a blower-assembly 207. Blower-assembly 207 can be associated with a thermal heating source and a thermometer (not shown in the figures). The heating source can be a heating coil. Other example embodiments of AFU 200 may comprise two or more blower-assemblies along the AFU. The blower assembly 207 can be configured to circulate air between the gape 206 and the internal chamber 204 while heating the circulated air.

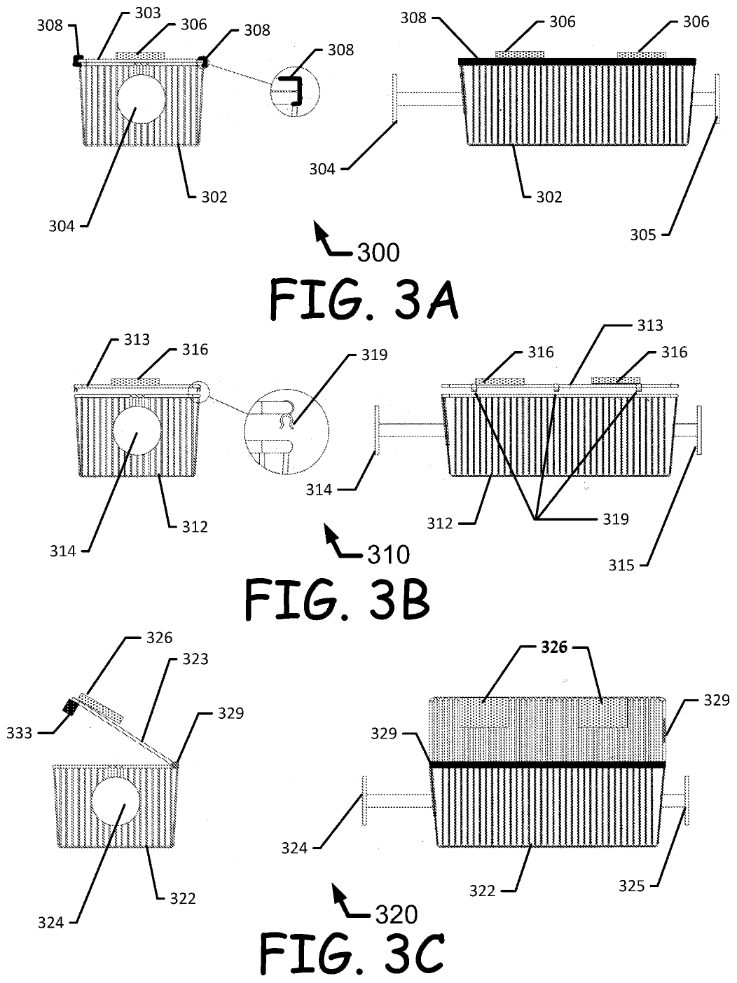

FIG. 3A illustrates a front view and a side view of an example of an FrB, FrB 300. FrB 300 may comprise a basket 302 and a cover 303. Cover 303 is associated with the basket 302 by two slots 308. One slot 308 is associated with one long edge of basket 302 and the other slot is associated with the other long edge of basket 302. In the present example cover 303 is associated with two metal-plates 306. Other example embodiments (not shown) may use other number of metal-plates 306, one metal-plate for example. The metal-plates 306 are configured to be used by a motion-system in order to carry the cover 303 and to slip it into the two slots 308 over the basket 302, thus, closing the basket 302.

The back end of FrB 300 can be associated with metal-plate 305 and the front end of FrB 300 can be associated with metal-plate 304. Metal plate 305 is configured to be associated, while the FrB 300 is in an AFU, with an electromagnet that is connected to a rotating motor of that AFU. Metal plate 304 is configured to be associated with an electromagnet that is connected with the motion-system in order to hold and convey the FrB 300 between the different racks.

FIG. 3B illustrates a front view and a side view of another example of FtB, FrB 310. FrB 310 may comprise a basket 312 and a cover 313. Cover 313 is associated with the basket 312 by a plurality of clips 319. In the present example cover 313 is associated with six clips 319, three on each long side of basket 312. In addition cover 313 is associated with two metal-plates 316. Other example embodiments (not shown) may use other number of metal-plates 316, one metal-plate for example. The metal-plates 316 are configured to be used by a motion-system in order to carry the cover 316 and to push it over the basket 312 in order to close the basket 312.

The back end of FrB 310 can be associated with metal-plate 315 and the front end of FrB 310 can be associated with metal-plate 314. While the FrB 310 is in an AFU the metal plate 315 is configured to be associated with an electromagnet that is connected to a rotating motor of that AFU. Metal plate 314 is configured to be associated with an electromagnet that is connected with the motion-system in order to hold and convey the FrB 310 between the different racks.

FIG. 3C illustrates a front view and a side view of a 3^{rd} example embodiment of an FrB, FrB 320. FrB 320 may comprise a basket 322 and a cover 323. One long edge of basket 322 can be associated with a long edge of cover 323 by one or more pivots 329. The opposite long edge of cover 323 can be associated with a locking mechanism 333. One example of locking mechanism 333 may comprise one or more clips along the edge of cover 323. Another example of locking mechanism 333 may comprise a pin and an actuator that are associated with the basket 322. The actuator can be configured to push the pin over the cover 323 in order to associate it with the basket 322. The actuator can be an electrical solenoid that can push or pull the pin against a spring, for example. The actuator can be controlled by controller 145 (FIG. 1). In addition cover 323 can be associated with one or more metal-plates 326. The one or more metal-plates 326 are configured to be used by a motion-system in order to close or open the basket 322.

The back end of FrB 320 can be associated with metal-plate 325 and the front end of FrB 320 can be associated with metal-plate 324. While the FrB 320 is in an AFU the metal plate 325 is configured to be associated, with an electromagnet that is connected to a rotating motor of that AFU. Metal plate 324 is configured to be associated with an electromagnet that is connected with the motion-system in order to hold and convey the FrB 320 between the different racks.

Other example embodiments of FrB (not shown in the figures) may not have the metal plates 305, 315, 325. Those FrBs can be used in an AFU that has an engaging mechanism other than electromagnet, adaptive-gripper-fingers for example. In such an AFU the adaptive-gripper-fingers can engage the FrB with the motor of the AFU.

Referring now to FIGS. 4A and 4B that illustrates a flowchart with relevant actions that can be implemented by an example process 400. Process 400 can be implemented by controller 145 (FIG. 1) of an example of IRAFS 100 in order to air frying a certain product. Process 400 can be initiated 402 by an operator of IRAFS 100 in order to start an air-frying cycle.

After initiation process 400 may prompt 404 the operator to select the type product and the required amount of the product. In some embodiments the required amount can be defined in grams. In other example embodiments the required amount can be define as a number of the required dishes. Yet, in other embodiments the required amount can be define by a descriptive term, such as but not limited to big, medium, small, etc.

After obtaining the information about the type of product and the required amount, process 400 may instruct 406 the motion-system 160 (FIG. 1) or an R-arm (not shown) to fetch an empty and clean FrB 115 from rack 110 (FIG. 1) and to convey it toward the frozen-dispenser 122 (FIG. 1) below the container of the defined product (124 or 126 or 128 FIG. 1). Then, process 400 may instruct 406 the dispenser to deliver the required amount of that product. In order to fetch the selected FrB, the HM of the motion-system 160 may attached its electromagnet to the metal plate 304 or 314 or 324 (FIG. 3A to 3C) and activate the electromagnet, thus associating the motion-system with the selected FrB 115 (FIG. 1).

At block 408, based on the type of product and the amount, process 400 may define parameters of the air-frying process. The defined parameters can be fetched from a look-up-table (LUT), which is stored in a non-transitory computer readable storage device. The parameters may comprise: the length of the coating process (LCP), the duration (Du) of the air-frying process and the minimum (Tmin) and the maximum (Tmax) temperature of the hot air. In some example embodiments the parameters may comprise also the flow speed of the hot air. The flow speed can be defined as an interval between SPmin and SPmax. SPmax and SPmin can be defined in cubic-feet per minute.

Next controller 145 (FIG. 1) may select 410 an empty AFU 132 (FIG. 1) for the current frying-process and accordingly may instruct the motion-system 160 to close the FrB with a cover (303 or 313 or 323, FIG. 3A-C) and to push 410 the closed FrB into the internal chamber of the selected AFU until the metal plate 305 or 315 or 325 is attached to an electromagnet at the far end of the internal chamber of that AFU. This electromagnet is associated with a rotating motor of that AFU. At this point of time the electromagnet, in the AFU, is activated in order to hold the FrB in the AFU and the electromagnet that is associated with the motion-system is turn of for releasing the metal plates 304 or 314 or 324 (FIG. 3A to 3C) and separating the FrB from the motion-system. Then, the door of the selected AFU can be closed and the AFU is ready to start the air-frying process.

At block 412 process 400 may activate relevant elements that are related to the frying-process. Elements such as but not limited to: a timer, the pump of the coating process, the rotating motor of the selected AFU, the one or more blower-assemblies, and one or more thermal-sources. Then a decision is made 415 whether the timer is smaller than the value of the LCP. If 415 yes then the coating process proceeds. If 415 no, then the coating pump can be turn off and process 400 proceed to block 420.

At block 420 a decision is made whether the value of the timer is smaller than the frying duration parameter, Du. If 420 no, then process 400 may proceed to block 450 (FIG. 4B). If 420 the value of the timer is smaller than Du then a decision is made 430 whether the temperature of the hot air is below the value of Tmin. If 430 yes, then the controller 145 (FIG. 1) may turn on 434 the one or more thermal sources that are associated with the selected AFU and process 400 may proceed to block 444 and waits for a certain waiting period. The waiting period can be in the range of 20 to 100 seconds, 40 seconds for example. After the waiting period 444 process 400 may return to block 420.

Return now to block 430 If the temperature is not below Tmin, then a decision is made 440 whether the temperature is above Tmax. If 440 yes, then the controller 145 (FIG. 1) may turn off 442 the one or more thermal sources that are associated with the selected AFU and process 400 may proceed to block 444 and waits for the waiting period. If 440 the temperature is smaller than the value of Tmax, then process 400 may proceed to block 444.

At block 450 (FIG. 4B) the controller 145 (FIG. 1) may turn off the one or more blowers, the one or more thermal sources and may open the AFU. Next a decision is made 452 whether salt is needed. If 452 no, then the process proceed to block 460. If 452 salt is needed, then the motion-system 160 (FIG. 1) is instructed 454 to place the FrB below the salt station 152 (FIG. 1) and the controller may instruct the salt station 152 to scatter 456 salt while the motor that is associated with the HM is instructed 456 to rotate the FrB 115b (FIG. 1) for few seconds, 10 seconds for example. Then the process proceeds to block 460.

At block 460 a decision is made whether a first topping is needed. The first topping can be mayonnaise, for example. If 460 no, then the process proceed to block 470. If 460 mayonnaise is needed, then the motion-system 160 (FIG. 1) is instructed 462 to place the FrB below the mayonnaise station 154 (FIG. 1) and the controller may instruct the mayonnaise station 154 to inject 464 mayonnaise while the motor that is associated with the HM is instructed 464 to rotate the FrB 115b (FIG. 1) for few seconds, 10 seconds for example. Then the process proceeds to block 470.

At block 470 a decision is made whether a second topping is needed. The second topping can be ketchup, for example. If 470 no ketchup is needed, then the process proceed to block 476. If 470 ketchup is needed, then the motion-system 160 (FIG. 1) is instructed 472 to place the FrB below the ketchup station 156 (FIG. 1) and the controller may instruct the ketchup station 154 to inject 474 ketchup while the motor that is associated with the HM is instructed 474 to rotate the FrB 115b (FIG. 1) for few seconds, 10 seconds for example. Then the process proceeds to block 476.

Next, at block 476 the motion-system can be instructed to convey the FrB above a servicing station, to open the FrB and to turn it upside down in order to drop the fried product over a tray at the servicing station. Then the current air-frying cycle is terminated 480 and the empty FrB is delivered to a cleaning section (not shown in the figures).

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

1. An air-frying Unit (AFU) that is associated with an industrial-robotic-air-frying system (IRAFS), comprising:
an external-chamber;
an internal-chamber; and
a gap between the external-chamber and the internal-chamber;
wherein, the internal-chamber is associated with a blower-assembly that is configured to push hot air into the internal-chamber; and
wherein the hot air is circulated via the gap.

2. The AFU of claim 1, wherein the internal-chamber has a shape of cylinder.

3. The AFU of claim 1, wherein the internal-chamber is associated with a coating-pipe having a plurality of nozzles.

4. The AFU of claim 3, wherein one end of the coating-pipe is close and the other end of the coating pipe is associated with a container of oil via a pump.

5. The AFU of claim 1, wherein the internal-chamber is associated with a motor that is configured to rotate a frying-basket (FrB) that is in the AFU.

6. The AFU of claim 5, wherein the motor is associated with an engaging mechanism that is configured to engage the motor with the FrB while the FrB is in the AFU.

7. The AFU of claim 6, wherein the engaging mechanism comprises an electromagnet.

8. The AFU of claim 7, wherein the FrB comprises a metal plate that is configured to be associated with the electromagnet.

9. The AFU of claim 1, wherein the blower-assembly comprises a thermal heating source.

10. The AFU of claim 9, wherein the thermal heating source is a heating coil.

11. The AFU of claim 1, wherein the surface of the internal chamber has one or more openings.

12. The AFU of claim 11, wherein the one or more openings are configured to enable the hot air to exit toward the gap.

13. The AFU of claim 11, wherein at least one opening from the one or more openings is associated with a thermometer.

14. An industrial-robotic-air-frying system (IRAFS), wherein the IRAFS comprising:
i. a motion system;
ii. a dispenser that is configured to deliver one or more types of frozen products; and
iii. one or more air-frying Units (AFUs);
wherein the motion system is configured to take an empty frying-basket (FrB), to convey the empty FrB toward the dispenser for loading a certain amount of a certain frozen product into the FrB, and to convey the loaded FrB into an AFU from the one or more AFUs.

15. The IRAFS of claim 14, wherein the motion system comprises a multi-axis gantry system.

16. The IRAFS of claim 14, wherein the frozen products comprise frozen french-fries.

17. The IRAFS of claim 14, wherein the motion system comprises a weighting apparatus that is configured to measure the weight of the loaded FrB.

18. The IRAFS of claim 14, further comprising a controller that is configured to control the operation of the IRAFS.

19. The IRAFS of claim 18, wherein the controller is configured to obtain the type of product, the weight of the loaded FrB and accordingly define the duration of the frying process and the temperature of the hot air.

20. The IRAFS of claim 14, wherein each AFU from the one or more AFUs is associating with a coating pipe.
